(19) United States
(12) Patent Application Publication
(10) Pub. No.: US 2026/0087048 A1
(43) Pub. Date: Mar. 26, 2026

(54) METHOD FOR TRAINING TEXT RETRIEVAL MODEL, METHOD FOR RETRIEVING TEXT, AND RELATED APPARATUSES

(71) Applicant: Beijing Baidu Netcom Science Technology Co., Ltd., Beijing (CN)

(72) Inventors: Jiawen SONG, Beijing (CN); Junwei XING, Beijing (CN); Yunpeng PENG, Beijing (CN); Hui LI, Beijing (CN); Bingfei ZHANG, Beijing (CN); Sai GAO, Beijing (CN); Xiangfei MIN, Beijing (CN); Wenqing XU, Beijing (CN); Guanyu CHEN, Beijing (CN)

(21) Appl. No.: 19/408,059

(22) Filed: Dec. 3, 2025

(30) Foreign Application Priority Data
Aug. 15, 2025 (CN) 202511149972.1

(51) Int. Cl. G06F 16/3332; G06F 40/284; G06F 40/40

(52) U.S. Cl. CPC G06F 16/3334; G06F 40/284; G06F 40/40

(57) ABSTRACT

A method for training a text retrieval model, a method for retrieving a text and corresponding apparatuses are provided. An implementation of method comprises: compressing each pair of a query term sample and a candidate text sample into one character string sample; processing the character string sample using a feature extraction sub-model in a text retrieval model to obtain hidden-layer features of tokens in the character string sample; calculating feature weights of the hidden-layer features of the tokens using a weight determination sub-model in the text retrieval model; calculating, based on the feature weights and the hidden-layer features of the corresponding tokens, to obtain a correlation score between the query term sample and the candidate text sample using a similarity calculation sub-model in the text retrieval model; and training, based on the correlation score, the text retrieval model by means of contrastive learning.

### CROSS-REFERENCE TO RELATED APPLICATIONS

This application claims the priority from Chinese Patent Application No. 202511149972.1, filed in the National Intellectual Property Administration (CNIPA) on Aug. 15, 2025, the contents of which are hereby incorporated by reference in their entirety.

### TECHNICAL FIELD

The present disclosure relates to the field of artificial intelligence technology, and particularly to a method for training a text retrieval model, a method for retrieving a text, corresponding apparatuses, an electronic device, a computer readable storage medium, and a computer program product.

### BACKGROUND

With the continuous development of text retrieval technology, more and more application scenarios such as the field of information retrieval, the field of intelligent question and answer and the field of recommendation systems have put forward higher requirements on text matching and retrieval capabilities.

### SUMMARY

Embodiments of the present disclosure provide a method for training a text retrieval model, a method for retrieving a text, an apparatus, an electronic device, and a computer readable storage medium.

In a first aspect, an embodiment of the present disclosure provides a method for training a text retrieval model, including: compressing each pair of a query term sample and a candidate text sample into one character string sample; processing the character string sample using a feature extraction sub-model in a text retrieval model to obtain hidden-layer features of tokens in the character string sample; calculating feature weights of the hidden-layer features of the tokens using a weight determination sub-model in the text retrieval model; calculating, based on the feature weights and the hidden-layer features of the corresponding tokens and using a similarity calculation sub-model in the text retrieval model, to obtain a correlation score between the query term sample and the candidate text sample; and training, based on the correlation score, the text retrieval model by means of contrastive learning.

In a second aspect, an embodiment of the present disclosure provides an apparatus for training a text retrieval model, including: a compressing module, configured to compress each pair of a query term sample and a candidate text sample into one character string sample; a feature extracting module, configured to process the character string sample using a feature extraction sub-model in a text retrieval model to obtain hidden-layer features of tokens in the character string sample; a weight calculating module, configured to calculate feature weights of the hidden-layer features of the tokens using a weight determination sub-model in the text retrieval model; a similarity calculating module, configured to calculate, based on the feature weights and the hidden-layer features of the corresponding tokens and using a similarity calculation sub-model in the text retrieval model, to obtain a correlation score between the query term sample and the candidate text sample; and a training module, configured to train, based on the correlation score, the text retrieval model by means of contrastive learning.

In a third aspect, an embodiment of the present disclosure provides a method for retrieving a text, including: compressing a query term and a candidate text into one character string; inputting the character string into a text retrieval model to calculate a correlation score between the query term and the candidate text; and determining a text retrieval result corresponding to the query term from the candidate text based on the correlation score, where the text retrieval model is obtained according to the method for training a text retrieval model described in any one of the implementations of the first aspect.

In a fourth aspect, an embodiment of the present disclosure provides an apparatus for training a text retrieval model, including: a compressing unit, configured to compress a query term and a candidate text into one character string; a correlation score calculating unit, configured to input the character string into a text retrieval model to calculate a correlation score between the query term and the candidate text; and a retrieving unit, configured to determine a text retrieval result corresponding to the query term from the candidate text based on the correlation score, where the text retrieval model is obtained according to the apparatus for training a text retrieval model described in any one of the implementations of the second aspect.

In a fifth aspect, an embodiment of the present disclosure provides an electronic device, including: at least one processor; and a memory, in communication with the at least one processor, where the memory stores instructions executable by the at least one processor, and the instructions are executed by the at least one processor, to enable the at least one processor to perform the method for training a text retrieval model described in any one of the implementations of the first aspect and the method for retrieving a text described in any one of the implementations of the third aspect.

In a sixth aspect, an embodiment of the present disclosure provides a non-transitory computer readable storage medium, storing a computer instruction, where the computer instruction is used to cause a computer to perform the method for training a text retrieval model described in any one of the implementations of the first aspect and the method for retrieving a text described in any one of the implementations of the third aspect.

It should be understood that the content described in this part is not intended to identify key or important features of the embodiments of the present disclosure, and is not used to limit the scope of the present disclosure. Other features of the present disclosure will be easily understood through the following description.

### BRIEF DESCRIPTION OF THE DRAWINGS

Through detailed descriptions of non-limiting embodiments given with reference to the following accompanying drawings, other features, objectives and advantages of the present disclosure will be more apparent:

FIG. 1 illustrates an exemplary system architecture in which embodiments of the present disclosure may be applied;

FIG. 2 is a flowchart of a method for training a text retrieval model provided by an embodiment of the present disclosure;

FIG. 3 is a flowchart of a method for training a text retrieval model in combination with an application scenario provided by an embodiment of the present disclosure;

FIG. 4 is a flowchart of a method for retrieving a text provided by an embodiment of the present disclosure;

FIG. 5 is a structural block diagram of an apparatus for training a text retrieval model provided by an embodiment of the present disclosure;

FIG. 6 is a structural block diagram of an apparatus for retrieving a text provided by an embodiment of the present disclosure; and

FIG. 7 is a schematic structural diagram of an electronic device adapted to perform the method for training a text retrieval model and/or the method for retrieving a text, provided by an embodiment of the present disclosure.

### DETAILED DESCRIPTION OF EMBODIMENTS

Exemplary embodiments of the present disclosure are described below in combination with the accompanying drawings, and various details of the embodiments of the present disclosure are included in the description to facilitate understanding, and should be considered as exemplary only. Accordingly, it should be recognized by one of ordinary skill in the art that various changes and modifications may be made to the embodiments described herein without departing from the scope and spirit of the present disclosure. Also, for clarity and conciseness, descriptions for well-known functions and structures are omitted in the following description. It should be noted that the embodiments in the present disclosure and the features in the embodiments may be combined with each other on a non-conflict basis.

In the technical solution of the present disclosure, the acquisition, storage, use, processing, transmission, provision, disclosure, etc. of the personal information of a user all comply with the provisions of the relevant laws and regulations, and do not violate public order and good customs.

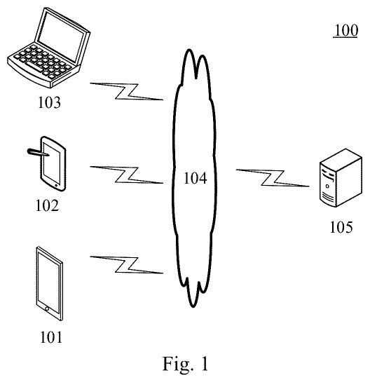

FIG. 1 illustrates an exemplary system architecture 100 in which embodiments of a method and apparatus for training a text retrieval model, a method and apparatus for retrieving a text, an electronic device and a computer readable storage medium provided by the present disclosure may be applied.

As shown in FIG. 1, the system architecture 100 may include terminal device(s) 101, 102, 103, a network 104 and a server 105. The network 104 serves as a medium providing a communication link between the terminal device(s) 101, 102, 103 and the server 105. The network 104 may include various types of connections, for example, wired or wireless communication links, or optical fiber cables.

A user may use the terminal device(s) 101, 102, 103 to interact with the server 105 via the network 104, to receive or send messages, etc. On the terminal device(s) 101, 102, 103 and the server 105, various applications for implementing the information communication between the terminal device(s) 101, 102, 103 and the server 105 may be installed, for example, a text retrieval model training application, and a text retrieval application.

The terminal device(s) 101, 102, 103 and the server 105 may be hardware or software. When being the hardware, the terminal device(s) 101, 102, 103 may be various electronic devices having a display screen, the electronic devices including, but not limited to, a smartphone, a tablet computer, a laptop portable computer, a desktop computer, and the like. When being the software, the terminal device(s) 101, 102, 103 may be installed in the above electronic devices. The terminal device(s) may be implemented as a plurality of pieces of software or a plurality of software modules, or may be implemented as a single piece of software or a single software module, which will not be particularly limited here. When being the hardware, the server 105 may be implemented as a distributed server cluster composed of a plurality of servers, or may be implemented as a single server. When being the software, the server may be implemented as a plurality of pieces of software or a plurality of software modules, or may be implemented as a single piece of software or a single software module, which will not be particularly limited here.

The server 105 can provide various services through various built-in applications. An application that can be used to train a text retrieval model is taken as an example. When running the text retrieval model training application, the server 105 can achieve the following effect: the robustness of model training and the stability of the training are improved.

Here, the text retrieval model can be trained by the built-in text retrieval model training application on the server 105 by: compressing each pair of a query term sample and a candidate text sample into one character string sample; processing the character string sample using a feature extraction sub-model in a text retrieval model to obtain hidden-layer features of tokens; calculating feature weights of the hidden-layer features using a weight determination sub-model in the text retrieval model; calculating, based on the feature weights of the hidden-layer features and the hidden-layer features and using a similarity calculation sub-model in the text retrieval model, to obtain a correlation score between the query term sample and the candidate text sample; and training, based on the correlation score, the text retrieval model by means of contrastive learning.

Since the training for the text retrieval model needs to occupy many computing resources and needs a strong computing capability, the method for training a text retrieval model provided in subsequent embodiments of the present disclosure is generally performed by the server 105 having a strong computing capability and many computing resources. Correspondingly, the apparatus for training a text retrieval model is generally provided in the server 105. However, it should also be noted that, when having a computing capability and computing resources that satisfy requirements, the terminal device(s) 101, 102, 103 can also complete, through the text retrieval model training application installed thereon, the computations originally performed by the server 105, to output the same result as that of the server 105. Correspondingly, the apparatus for training a text retrieval model can alternatively be provided in the terminal device(s) 101, 102, 103. In this situation, the exemplary system architecture 100 may alternatively not include the server 105 and the network 104.

Clearly, the server configured to train and obtain a text retrieval model may be different from the server that calls a trained text retrieval model. Specifically, model distillation may be performed on the text retrieval model trained by the server 105, to obtain a lightweight text retrieval model suitable for being installed in the terminal device(s) 101, 102, 103. That is, according to the recognition accuracy actually required, it is possible to flexibly choose to use the lightweight text retrieval model in the terminal device(s) 101, 102, 103, or choose to use the complicated text retrieval model in the server 105.

It should be appreciated that the numbers of the terminal devices, the networks and the servers in FIG. 1 are merely illustrative. Any number of terminal devices, networks and servers may be provided based on actual requirements.

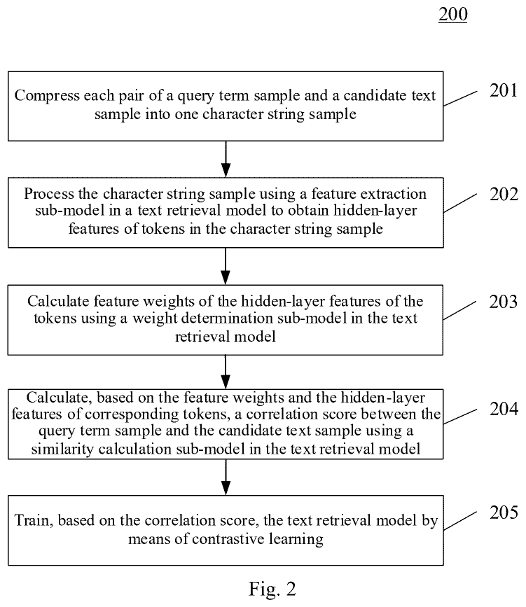

Referring to FIG. 2, FIG. 2 is a flowchart of a method for training a text retrieval model provided by an embodiment of the present disclosure. This method may be applied to the system architecture 100 in FIG. 1 (e.g., the server 105 shown in FIG. 1), or may be applied to a processor or an other electronic device, which is not limited in the present disclosure. Here, the process 200 includes the following steps.

Step 201, compressing each pair of a query term sample and a candidate text sample into one character string sample.

Particularly, the query term sample and the candidate text sample may be training samples that are labelled in advance, or a published training set may be directly used as the query term sample and the candidate text sample, which is not limited in the present disclosure. Here, a query term may be a question, a requirement, or a keyword, and the corresponding candidate text may be a title, an abstract, a document fragment, a whole document, or the like. As an example, the query term is “How to relieve fatigue,” and the candidate sample may be a webpage title/summary, etc. As another example, the query term is “application of models in medicine,” and the candidate sample may be the abstract of a paper, the whole paper, etc.

Here, that an executing body (e.g., a processor, or the server in FIG. 1) compresses the query term sample and the candidate text sample into one character string sample, means directly merging the two samples (the query term sample and the candidate text sample) into one character string sample.

In some embodiments, the executing body (e.g., the processor, or the server in FIG. 1) may merge a query term and a candidate text into one character string by means of adding a corresponding prefix. For example, if the query term is A and the candidate text is B, the character string obtained by the compressing may be: “query term A candidate text B.”

In some embodiments, the executing body (e.g., the processor, or the server in FIG. 1) may merge the query term sample and the candidate text sample into one character string by means of adding a delimiter between the query term sample and the candidate text sample. For example, if the query term is A and the candidate text is B, the character string obtained by the compressing may be: “A, B,” “A:B,” or the like.

In some embodiments, when the length of the stitched character string exceeds a preset length, the executing body (e.g., the processor, or the server in FIG. 1) may alternatively truncate the candidate text, for example, preferentially retain a paragraph with a high occurrence rate of the query term, or adopt a sliding window for segment processing. Alternatively, the executing body may simplify the candidate sample through feature extraction, or the like.

The query term sample and the candidate text sample are two separate samples, and accordingly, it is difficult to capture a deep semantic interaction therebetween. The executing body (e.g., the processor, or the server in FIG. 1) in the embodiment of the present disclosure stitches the query term and the candidate text into a single continuous character string, such that subsequently a model can directly learn the context dependency relationship between the query term and the text, thereby improving the precision of semantic matching.

Step 202, processing the character string sample using a feature extraction sub-model in a text retrieval model to obtain hidden-layer features of tokens in the character string sample.

Particularly, a hidden-layer feature refers to a vector representation generated by processing the inputted character string sample by the feature extraction sub-model, and representing semantic information of the character string sample. The feature extraction sub-model is formed by stacking a plurality of feature extraction layers, and the output of each feature extraction layer is a context feature representation learned by this layer. The executing body (e.g., the processor, or the server in FIG. 1) inputs the compressed character string into the feature extraction sub-model. Based on the query term sample and the candidate text sample in the character string, each network layer of the feature extraction sub-model captures the semantic relationship of different subspaces through an attention mechanism to obtain a hidden-layer feature. Here, the hidden-layer feature may be an initial term vector captured from the character string sample, for example, a token identifier (ID), a position, or a paragraph. Further, based on the acquired initial term vector, an information analysis is performed on the grammar, a partial semantic meaning, a global semantic meaning, etc. in the character string to obtain an advanced feature, etc. in the character string sample.

In addition, the inputted character string sample is composed of a plurality of tokens, and a token may refer to a word, a character, a punctuation, or even one byte in the character string sample. After the character string sample is inputted into the feature extraction sub-model, the feature extraction sub-model divides the character string sample into a plurality of tokens according to a preset rule, and each token corresponds to one token id (identifier). The feature extraction sub-model processes the character string sample based on the token id. Finally, the feature extraction sub-model correspondingly outputs one hidden-layer feature for each token id. Here, the preset rule may refer to the attribute of a word (e.g., a verb, a noun, or an adjective), a number of words, or the like.

For example, the inputted character string sample is “I love reading,” and the feature extraction sub-model divides the character string sample into three tokens (“I,” “love” and “reading”), which correspond to three token ids. Finally, the feature extraction sub-model outputs three hidden-layer features for the three token ids.

Here, the feature extraction sub-model may be a convolutional neural network (CNN)-based feature extractor, for example, a LeNet-5 model, an AlexNet, an attention mechanism enhanced CNN (an SENet model, an SKNet model, etc.), a lightweight/high-efficiency CNN model (a MobileNet v1/v2/v3 model, an EfficientNet model, etc.). The feature extraction sub-model may alternatively be a Transformer-based feature extractor, for example, a language model Transformer (a BERT model, a GPT series model, etc.). The feature extraction sub-model may alternatively be a multi-modal-based feature extractor, for example, a CLIP model, an ALIGN model, or a FILIP model.

The specific structure of the feature extraction sub-model is not limited in the present disclosure, as long as the feature extraction sub-model can extract the corresponding hidden-layer feature from the character string.

Step 203, calculating feature weights of the hidden-layer features of the tokens using a weight determination sub-model in the text retrieval model.

Particularly, the character string sample may be split into a plurality of tokens, and each token corresponds to one hidden-layer feature. In a text retrieval task, different weights may be allocated to the features of the tokens to highlight the role of an important token.

Step 204, calculating, based on the feature weights and the hidden-layer features of corresponding tokens, a correlation score between the query term sample and the candidate text sample using a similarity calculation sub-model in the text retrieval model.

Particularly, for a text retrieval task, the importance degrees of tokens may be different. Therefore, the hidden-layer features of tokens may be fused according to the importance degrees of the tokens in the text retrieval to obtain a global feature, and the correlation score between the query term sample and the candidate text sample may be calculated using the similarity calculation sub-module according to the global feature of the character string sample, which makes the obtained correlation score more accurate, thereby improving the precision of model training.

Step 205, training, based on the correlation score, the text retrieval model by means of contrastive learning.

Here, the text retrieval model may include the feature extraction sub-model, the weight calculation sub-module, and the similarity calculation sub-model.

Particularly, in text retrieval, the core objective of the contrastive learning is to make the representation of a query term as close as possible to that of a positive sample (a correlated candidate), and at the same time as far away as possible from that of a negative sample (an uncorrelated candidate), so as to train the text retrieval model.

According to the embodiment of the present disclosure, the query term and the corresponding candidate text are compressed into one character string, and the character string is used as the input to the feature extraction sub-model, such that the feature extraction sub-model can directly learn the context dependency relationship between the query term and the text, thereby improving the precision of the obtained hidden-layer features. Further, the global feature of the character string sample is determined by determining the weights of the hidden-layer features corresponding to tokens in the character string sample, and the correlation score between the query term sample and the candidate text sample is calculated based on the global feature of the character string sample, which makes the calculated correlation score more accurate. Accordingly, by training the text retrieval model based on this correlation score, the precision and accuracy of training the text retrieval model can be improved.

For step 202 in FIG. 2, the information in the character string sample can be compressed into one special token in the process of processing the character string sample using the feature extraction sub-model in the text retrieval model. Therefore, the tokens in the character string sample include the tokens themselves in the character string sample, and may additionally include one special token. A detailed implementation of step 202 in FIG. 2. is given in the following embodiments.

In some embodiments, the processing the character string sample using a feature extraction sub-model in a text retrieval model to obtain hidden-layer features of tokens in the character string sample includes: processing the character string sample using the feature extraction sub-model in the text retrieval model to generate an aggregate token; splitting the character string sample into a plurality of split tokens using the feature extraction sub-model; and performing feature extraction on a plurality of tokens containing the aggregate token and the plurality of split tokens using the feature extraction sub-module, and outputting the hidden-layer features of the tokens.

Particularly, in the process of processing the inputted character string sample by the feature extraction sub-model, the character string sample is first split into a plurality of split tokens according to a certain rule, and each token corresponds to one token id, such that hidden-layer feature extraction may be performed on each token based on the token id. In addition, in the process of processing the inputted character string sample by the feature extraction sub-model, the feature extraction sub-model may compress the information of the character string sample to obtain an aggregate token. The aggregate token theoretically contains most of the valid information in the character string sample. Therefore, in embodiments of the present disclosure, the aggregate token may further be added to the character string sample. When the hidden-layer feature extraction being performed, the hidden-layer feature extraction is performed on the aggregate token and the split tokens, that is, a dual-extraction is performed on the feature in the character string sample, which can ensure that the obtained hidden-layer feature is more accurate and comprehensive.

Clearly, since the aggregate token theoretically contains most of the valid information in the character string sample, in some embodiments of the present disclosure, the subsequent similarity calculation may alternatively be directly performed through the hidden-layer feature of the generated aggregate token. However, if the calculation is excessively dependent on the compressed information in the aggregate token, the accuracy of the subsequent correlation score calculation will be affected if the compressed information in the aggregate token is not accurate or comprehensive enough, resulting in poor stability of the trained text retrieval model. Moreover, if the calculation of the hidden-layer feature is performed based on this aggregate token, it may require to additionally add the aggregate token to the character string sample every time, resulting in the increase of additional token calculation redundancy. Moreover, if the hidden-layer feature extraction is performed depending only on the aggregate token, it will cause the following problem that, in the subsequent inference stage, if it is desired to acquire a similarity score by intercepting some tokens from a historical hidden-layer feature, it is required to add the aggregate token again and perform a whole token calculation. In some embodiments of the present disclosure, the hidden-layer feature extraction may alternatively be performed based only on the split tokens which are obtained by splitting the character string sample.

The output of each layer in the feature extraction sub-model is the context feature representation learned by the each layer, and the intensities of information captured by different layers are different. Therefore, in embodiments of the present disclosure, the hidden-layer features of tokens may alternatively be determined based on the number of layers in the feature extraction sub-model. A detailed implementation is given below.

In some embodiments, the processing the character string sample using a feature extraction sub-model in a text retrieval model to obtain hidden-layer features of tokens in the character string sample includes: outputting hidden-layer sub-features corresponding to the respective tokens using the respective network layers in the feature extraction sub-model; determining network weights of the hidden-layer sub-features outputted from the respective network layers in the feature extraction sub-model; and determining the hidden-layer features corresponding to the respective tokens based on the network weights and the corresponding hidden-layer sub-features.

Particularly, a hidden-layer feature of a token includes a hidden-layer sub-feature of the token outputted from a network layer in the feature extraction sub-model.

After the character string sample obtained by stitching the query term sample and the candidate text sample is inputted into the feature extraction sub-model, the feature extraction sub-model captures hidden-layer features in the character string sample mainly in units of tokens. Here, an input layer of the feature extraction sub-model is mainly used to capture an initial term vector, for example, a token identifier (ID), or a position. A lower layer in the feature extraction sub-model is configured to capture a local grammatical feature, for example, a basic grammatical structure, and proximity co-occurrence information. A middle layer of the feature extraction sub-model may capture a local semantic feature, for example, a phrase combination, and short-distance dependency. A higher layer of the feature extraction sub-model is configured to capture a global semantic feature, for example, a deep inference, and an abstract concept. Finally, an output layer of the feature extraction sub-model performs a task adaptation and outputs a hidden-layer feature related to a text retrieval.

When the hidden-layer feature extraction is performed, the output of the last layer (or the penultimate layer) is usually directly used as the overall representation of the character string sample formed by compressing the query term sample and the candidate text sample, but in this way, the underlying syntax information may be ignored and the exact matching signal may be lost.

According to the embodiment of the present disclosure, the outputs of the respective layers in the feature extraction sub-model may be provided with different output weights, and thus, the retrieval robustness can be improved by combining the advantages of different layers. For example, one or more layers may be selected from the middle layer and the higher layer in the feature extraction sub-model and then are provided with different weights, then, based on the weights of the selected layers, the hidden-layer features of the respective tokens in the character string are finally outputted.

It should be noted that the embodiment of the present disclosure may also be combined with the previous embodiment, that is, the tokens in the embodiments of the present disclosure may include the aggregate token or may not include the aggregate token, which is not limited in the present disclosure.

For step 203 in FIG. 2, during calculating the feature weights of the hidden-layer features of the respective tokens, the feature weight of the hidden-layer feature of a token may be determined based on the importance degree of the token in the character string sample in a text retrieval. A detailed implementation is given below.

In some embodiments, the calculating feature weights of the hidden-layer features of the respective tokens using a weight determination sub-model in the text retrieval model includes: determining a linguistic feature of a token using the weight determination sub-model in the text retrieval model; and calculating the feature weight of the hidden-layer feature of the token based on the linguistic feature of the token.

Particularly, for a text retrieval task, the importance degrees of the respective tokens in a text retrieval may be different. Therefore, the hidden-layer features of tokens may be fused according to the importance degrees of the tokens in the text retrieval to obtain a global feature. Here, the importance degree of a token in the text retrieval may be determined based on the linguistic feature of the token in the character string. The linguistic feature of the token includes at least one of: a part of speech, a syntactic component and a character category of the token.

In some embodiments, the weight determination sub-model in the text retrieval model may divide the tokens into a verb, a noun, an adjective and an adverb based on a part of speech, and determine the feature weight of a hidden-layer feature of a token based on the part of speech of the token.

Particularly, in a text retrieval scenario, a noun usually carries more subject information, and thus may be provided with a higher weight. A verb is generally used to describe a relationship and a behavior, and thus may be provided with a next-higher weight. An adjective or a function word such as an adverb, a preposition or an article plays the role of modification during a text retrieval, and thus may be provided with a relatively lower weight. Alternatively, the feature weight corresponding to each part of speech may be provided in advance. For example, after being obtained, the hidden-layer feature of each token is multiplied by a predefined weighting factor (e.g., the weighting factor of the noun is 1.2, the weighting factor of the verb is 1.0, the weighting factor of the adjective is 0.9, and the weighting factors of the others are 0.5). Alternatively, the weight determination sub-model in the text retrieval model may alternatively appropriately adjust the above weight of a token based on the context semantic meaning of the token or the number of times the token occurs.

According to the embodiment of the present disclosure, the feature weight of the hidden-layer feature corresponding to a token is determined based on the part of speech of the token. Accordingly, the keyword of the content can be enhanced, the action semantic meaning can be preserved, and the substantive word can be reinforced and the function word can be weakened, so as to make the representation more inclined to the content word, which improves the accuracy of the subject relevance, thereby improving the efficiency and accuracy of the text retrieval.

In some embodiments, the weight determination sub-model in the text retrieval model may divide the tokens into a subject, a predicate, an object and others according to the syntactic component, and determine the feature weight of a hidden-layer feature of a token based on the syntactic component of the token.

Particularly, since the subject, the predicate and the object carry the core semantic meaning of a sentence, and the corresponding feature weights may be set to higher weights, while the others may be provided with relatively lower weights. For example, a dependency syntactic parser or component syntactic parser is used to identify the syntactic role of a-token, and then a weight is allocated thereto (e.g., the weights of the subject and the object are 1.2, the weight of the predicate is 1.1, the weight of a modifier is 1.0, and the weights of the others are 0.8).

According to the embodiment of the present disclosure, by determining the corresponding feature weights based on the syntax components corresponding to the respective tokens, the core part of the character string can be highlighted, and the accuracy of semantic matching can be improved for a long character string or a complex character string, and especially in a question and answer retrieval, the subject in a question can be quickly aligned with the subject in a candidate text, thereby improving the accuracy and efficiency of the text retrieval model.

In some embodiments, the weight determination sub-model in the text retrieval model may divide the tokens into a letter character, a punctuation character and others according to the character category, and determine the feature weight of a hidden-layer feature of a token based on the character category of the token.

Particularly, the character category may include a letter character, a punctuation character, a byte-level character, and others. Here, the letter character (especially a letter and a Chinese character) is provided with a higher weight. The weight of a punctuation mark is very low or even zero, because the punctuation mark generally does not carry a semantic meaning. The byte-level character is generally not used for weight adjustment, because a pre-trained model generally uses a sub-word or a word. For example, in a character-level representation (e.g., using characters CNN or sub-word embedding), the weights are set according to character types (for example, the weight of a letter/Chinese character is set to 1, the weight of a number is set to 0.8, and the weight of a punctuation is set to 0).

According to the embodiment of the present disclosure, by determining the corresponding feature weight based on the character type corresponding to a token, a meaningless symbol can be filtered out, such that the model pays more attention to a character of practical significance. In addition, noise data can further be processed.

In addition, in an embodiment of the present disclosure, any combination of the part of speech, the syntactic component and the character type may be performed based on a requirement (e.g., a length or a structure of a character string sample), and the feature weight corresponding to a token may be determined in combination with many methods. As an example, the initial feature weight corresponding to a token is first determined based on the part of speech, then, the obtained initial feature weight is adjusted based on the syntactic component to obtain the feature weight corresponding to the hidden-layer feature corresponding to the token. As another example, it may first filter out a token in the character string that does not carry a semantic meaning based on the character type, and then determine the feature weights corresponding to respective tokens based on the part of speech and/or syntactic component.

According to embodiments of the present disclosure, the weight determination sub-model in the text retrieval model is used to determine the feature weight of the hidden-layer feature of each token based on the part of speech of each token corresponding to the character string sample. In this way, the main feature in the character string sample can be reinforced, and the irrelevant feature in the character string sample can be weakened, and thus, the finally obtained hidden-layer feature can better express the information in the character string sample, so as to the precision and accuracy of training the text retrieval model.

It should be noted that respective tokens in embodiments of the present disclosure may be only the split tokens obtained by splitting a character string sample, and may alternatively include an aggregate token on the basis of the split tokens, which is not limited in the present disclosure. Meanwhile, the hidden-layer feature in the embodiments of the present disclosure may be determined according to the hidden-layer sub-feature in the previous embodiment, or may be directly obtained based on the output of the last layer or the outputs of the last two layers in the feature extraction sub-model, which is not limited in the present disclosure.

In some embodiments, the weight determination sub-model is an attention pooling layer.

Particularly, the attention pooling layer (Attention Pooling) may dynamically adjust the weight of each feature according to the content of the inputted character string sample. For example, when Attention Pooling processes different queries, the model may automatically focus on features of different layers or features of different tokens, thereby improving flexibility. In addition, the Attention Pooling can further capture a dependency relationship between features, for example, in a sequence, the importance of a certain token may depend on the context of other tokens. Meanwhile, in a multi-layer feature fusion, a relationship between features of different layers can also be modeled. Furthermore, the attention mechanism is naturally applicable to a variable-length sequence, and the weight calculation is not limited by the length of the sequence. The Attention Pooling can further process different levels of semantic units (e.g., a word-level feature, a phrase feature, and a sentence feature) at the same time, and automatically allocate cross-level importance weights.

In addition, in embodiments of the present disclosure, another sub-model may be used to calculate the feature weight of the hidden-layer feature of each token, for example, a dynamic convolution and/or a capsule network, which is not limited in the present disclosure.

In some embodiments, the calculating, based on the feature weights and the hidden-layer features of the corresponding tokens and using a similarity calculation sub-model in the text retrieval model, to obtain a correlation score between the query term sample and the candidate text sample in the above step 204 includes: multiplying the feature weights by the hidden-layer features of corresponding tokens to obtain a plurality of multiplication results; summing the plurality of multiplication results to obtain a global hidden-layer feature; and inputting the global hidden-layer feature into the similarity calculation sub-model for calculation, and outputting the correlation score between the query term sample and the candidate text sample.

According to an embodiment of the present disclosure, the query term sample and the candidate text sample are first combined, then the feature extraction sub-model performs the hidden-layer feature extraction. Then, the hidden-layer feature weights attention_weight of different tokens are extracted by the attention pooling layer attention_pool according to the hidden-layer features. Next, the hidden-layer feature weights attention_weight are multiplied by the original hidden-layer features, and then multiplication results are summed to obtain the global hidden-layer feature. Finally, the global hidden-layer feature is converted into the correlation score between the query term and the candidate text through the similarity calculation sub-model. Accordingly, a contrastive learning loss value calculation is performed based on the correlation score to train the text retrieval model, so as to improve the precision and efficiency of training the text retrieval model.

In some embodiments, the inputting the global hidden-layer feature into the similarity calculation sub-model for calculation and outputting the correlation score between the query term sample and the candidate text sample includes: performing correlation score calculation using the similarity calculation sub-model in the text retrieval model: performing up-sampling mapping on the global hidden-layer feature to obtain an up-sampled feature and performing feature filtering on the up-sampled feature to obtain a filtered feature; performing down-sampling mapping on the filtered feature and the up-sampled feature to obtain a down-sampled feature; and calculating, based on the down-sampled feature, the correlation score between the query term sample and the candidate text sample.

Particularly, the purpose of up-sampling is to increase the size of a feature map (increase the resolution) and restore spatial details to generate a high-resolution output. Here, the up-sampling may be performed through an interpolation method (e.g., a nearest neighbor interpolation, and a bilinear interpolation), a transposed convolution method, a sub-pixel convolution method, or the like. The executing body (e.g., the processor, or the server in FIG. 1) in embodiments of the present disclosure may restore the spatial details in the character string sample by performing the up-sampling on the global hidden-layer feature, thereby improving the resolution.

Further, the executing body (e.g., the processor, or the server in FIG. 1) in embodiments of the present disclosure may further perform the feature filtering on the obtained up-sampled feature, to suppress some unimportant features in the up-sampled feature corresponding to the character string sample, thereby filtering out the unimportant features from the up-sampled feature. The obtained filtered feature contains the main feature of the global hidden-layer feature. Meanwhile, by filtering out the unimportant features from the up-sampled feature, the storage space of the global hidden-layer feature can be reduced. Moreover, during the subsequent processing performed based on the filtered feature, since the redundant features are removed, the computing resources can also be reduced, and the computing efficiency of the processor can be improved, thereby improving the efficiency of model training. Here, in embodiments of the present disclosure, a gating mechanism (e.g., an LSTM/GRU model) may be used to control the flow of features, redundant features may be removed through feature normalization and scaling (e.g., a Batch Normalization network), or redundant features may be removed using a sparse constraint (e.g., an L1 regularization).

The down-sampling mapping refers to the process of converting data from a high-resolution/high-sampling-rate representation to a low-resolution/low-sampling-rate representation. The down-sampling mapping is an inverse process to the above first up-sampling mapping and the above second up-sampling mapping. According to an embodiment of the present disclosure, down-sampling is performed on the filtered feature and the up-sampled feature obtained by the up-sampling mapping, to compress the dimension of a feature into an original dimension (that is, the dimension before the up-sampling mapping) to obtain the down-sampled feature. The down-sampled feature at this time can not only better express the feature in the character string sample, but also the dimension of the feature does not change. Meanwhile, through the down-sampling mapping, it may increase the receptive field, reduce an amount of calculation, and extract a high-level semantic feature. Here, the down-sampling mapping may be performed by linear processing, by non-linear processing (e.g., maximum pooling, and average pooling), or by other means, which is not limited in embodiments of the present disclosure.

Finally, the correlation score between the query term sample and the candidate sample calculated according to the down-sampled feature will be more accurate.

According to the method for training a text retrieval model provided in embodiments of the present disclosure, the resolution of the global hidden-layer feature can be improved by performing the up-sampling on the global hidden-layer feature, thus obtaining the spatial details in the global hidden-layer feature, and the feature filtering is performed on the unimportant features based on the spatial details in the global hidden-layer feature. Then, the feature is compressed to the original dimension by performing the down-sampling according to the up-sampled feature and the filtered feature, such that the down-sampled feature can better express the feature in the character string sample, and thus, the correlation score between the query term sample and the candidate sample that is calculated according to the down-sampled feature will become more accurate, thereby improving the feature extraction effect of the similarity calculation sub-model. Moreover, the text retrieval model is trained by means of the contrastive learning, thereby improving the efficiency and accuracy of model training.

In the above embodiments, the up-sampling is performed on the global hidden-layer feature. On the one hand, more spatial details in the hidden-layer feature are acquired through the up-sampling, and on the other hand, some unimportant features can be filtered out based on the spatial details in the global hidden-layer feature. Therefore, different up-sampling processing may be performed for different purposes. A detailed implementation is given in the following embodiments.

In some embodiments, the performing up-sampling mapping on the global hidden-layer feature to obtain an up-sampled feature and performing feature filtering on the up-sampled feature to obtain a filtered feature and the performing down-sampling mapping on the filtered feature and the up-sampled feature to obtain a down-sampled feature include: performing first up-sampling mapping on the global hidden-layer feature to obtain a first up-sampled feature, and performing feature filtering on the first up-sampled feature to obtain a filtered feature; performing second up-sampling mapping on the global hidden-layer feature to obtain a second up-sampled feature; and performing down-sampling mapping on the filtered feature and the second up-sampled feature to obtain the down-sampled feature.

In other words, according to embodiments of the present disclosure, the process of generating the filtered feature and the up-sampled feature (i.e., the second up-sampling) is divided into two branches, in which the first up-sampling mapping and feature filtering are performed on the global hidden-layer feature and the second up-sampling mapping is performed on the global hidden-layer feature respectively.

Here, the purpose of the first up-sampling is to obtain more spatial details in the global hidden-layer feature to filter an irrelevant feature. The purpose of the second up-sampling is to obtain more spatial details to obtain more feature details from the character string. Therefore, although both the first up-sampling and the second up-sampling refer to up-sampling processing, different sampling modes may be adopted according to different requirements. Particularly, for the first up-sampling, an appropriate up-sampling mode may be selected according to the precision of the feature filtering or the mode of the feature filtering, while for the second up-sampling, an appropriate up-sampling mode may be selected according to the required feature details. Alternatively, same up-sampling mode may be selected for the first up-sampling and the second up-sampling, or different parameters may be set in the same up-sampling mode.

In addition, since feature down-sampling is performed according to the up-sampled feature and the filtered feature obtained after the feature filtering, it may require to store the up-sampled feature as intermediate data in advance so as to be used in the subsequent down-sampling, which will increase the storage space, thereby affecting the computing efficiency. According to an embodiment of the present disclosure, the process of generating the filtered feature and the second up-sampled feature is divided into two branches. In this way, the obtained filtered feature and the second up-sampled feature can be directly processed without storing the intermediate result (the first sampled feature), which can save storage space. Meanwhile, the process of generating the first sampled feature and the filtered feature may be performed in parallel with the process of generating the second up-sampled feature, without increasing additional time overhead.

In some embodiments, the performing the down-sampling mapping on the filtered feature and the second up-sampled feature to obtain the down-sampled feature includes: performing a self-attention multiplication on the filtered feature and the second up-sampled feature, to obtain an enhanced feature; and performing the down-sampling mapping on the enhanced feature to obtain the down-sampled feature.

Particularly, the second up-sampled feature increases the size of the feature map of the global hidden-layer feature, thus restoring the spatial details in the global hidden-layer feature. Moreover, the filtered feature is obtained by filtering out the unimportant feature in the global hidden-layer feature containing the spatial details, thereby only preserving the important feature in the global hidden-layer feature. By performing the self-attention multiplication on the filtered feature and the second up-sampled feature obtained through the second up-sampled mapping, the important feature in the global hidden-layer feature can be reinforced, and the irrelevant feature in the global hidden-layer feature can be weakened, thus obtaining the self-attention enhanced feature in the character string sample. Finally, according to the down-sampled feature obtained by performing the down-sampling mapping on the enhanced feature, the important feature can also be reinforced and the irrelevant feature can also be weakened.

In the above embodiments, the down-sampled feature obtained through the down-sampling is only used to restore the feature dimension changed in the process of enhancing the important feature in the global hidden-layer feature and weakening the irrelevant feature to the original dimension. The dimension of the down-sampled feature does not change with respect to the dimension of the obtained global hidden-layer feature, but the down-sampled feature is different from the dimension of the required output feature. In order to obtain the output feature, it may be also required to restore the dimension of the down-sampled feature to the dimension required by the output. A detailed implementation is given below.

In some embodiments, the calculating the correlation score between the query term sample and the candidate text sample based on the down-sampled feature includes: performing dimension mapping on the down-sampled feature to obtain an output feature of an output dimension; and calculating the correlation score between the query term sample and the candidate text sample based on the output feature of the output dimension.

Particularly, the dimension mapping and the down-sampling mapping are similar, both of which are to process the dimension of a feature. Therefore, the dimension mapping and the down-sampling mapping may be performed in a similar way, and the difference therebetween lies in that different parameters are set based on the change of the dimension, and thus, the details of the dimension mapping process will not be repeatedly described in the present disclosure.

In the processing process of using the similarity sub-model, in order to improve the stability in the training process and enhance the robustness of the model, it may further process the down-sampled feature. A detailed implementation is given below.

In some embodiments, the performing dimension mapping on the down-sampled feature to obtain an output feature of an output dimension includes: performing over-fitting processing on the down-sampled feature to obtain a processed feature; performing normalization processing on the processed feature to obtain a normalized feature; and performing the dimension mapping on the normalized feature to obtain the output feature of the output dimension.

Particularly, in order to suppress the over-fitting in a model training process, the over-fitting processing may be performed by means of regularization, dropout, data enhancement, and the like, which improves a model generalization capability and reduces the sensitivity to noise in character string sample data, thereby preventing the model from falling into a local optimal solution. Further, through the normalization processing, it can accelerate the training and improve the performance of the text retrieval model. Alternatively, a data normalization, a batch normalization (BN), a layer normalization (LN), etc. may be employed.

According to the embodiments of the present disclosure, the robustness during the training of the text retrieval model and the stability of the training can be improved through the synergistic effect of the over-fitting and the normalization.

In the similarity calculation sub-model, a plurality of network layers are used to process the obtained hidden-layer feature to obtain the similarity between the query term sample and the candidate text sample. A detailed implementation is given below in combination with the network layer structure of the similarity calculation sub-model.

In some embodiments, the similarity calculation sub-model includes a first mapping layer, a second mapping layer, a first activation layer, a third mapping layer, and a second activation layer. The inputting the global hidden-layer feature into the similarity calculation sub-model for calculation and outputting the correlation score between the query term sample and the candidate text sample particularly includes: inputting the global hidden-layer feature into the first mapping layer for the first up-sampling mapping to output the first up-sampled feature, and performing the feature filtering on the first up-sampled feature using the first activation layer to output the filtered feature; inputting the global hidden-layer feature into the second mapping layer for the second up-sampling mapping to output the second up-sampled feature; inputting the filtered feature and the second up-sampled feature into the third mapping layer for the down-sampling mapping to output the down-sampled feature; and calculating the down-sampled feature using the second activation layer and outputting the correlation score between the query term sample and the candidate text sample.

Here, the up-sampling mapping is to map a low-dimensional global hidden-layer feature to a high-dimensional global hidden-layer feature, the down-sampling mapping is to restore a high-dimensional global hidden-layer feature to a low-dimensional global hidden-layer feature, and the dimension mapping is to output the dimension of the global hidden-layer feature as the output dimension of the output feature. That is, the up-sampling mapping, the down-sampling mapping and the dimension mapping are all to process the dimension of a feature. Thus, the first mapping layer, the second mapping layer and the third mapping layer may each be a linear mapping layer, through which the hidden-layer feature is mapped to a required dimension.

Because of its non-linear characteristic, an activation function can indirectly suppress some feature responses, thereby functioning as a feature selection in the network. Moreover, the structure of the activation function is relatively simple. In an embodiment of the present disclosure, the use of an activation layer not only can enable the feature filtering on the up-sampled feature, but also will not increase the difficulty in training the model due to the simple structure of the activation layer.

Here, the first mapping layer, the second mapping layer and the third mapping layer may have the same network layer structure, while different parameters may be set according to the dimensions of input data and output data. For example, an activation dimension is generally two times as large as an input dimension. Therefore, through the parameters corresponding to the first mapping layer, it may map the dimension of the global hidden-layer feature to the twice of the dimension of the global hidden-layer feature. The purpose of the second mapping layer is to acquire the spatial details in the global hidden-layer feature, and the higher the dimension corresponding to the obtained second sampled feature is, the more the corresponding spatial details are. Therefore, the parameters corresponding to the second mapping layer can be flexibly determined according to the requirement for the spatial details of the feature. The parameters corresponding to the corresponding third mapping layer may be determined according to the changes in the dimension of the global hidden-layer feature passing through the first mapping layer and the second mapping layer, so as to determine the parameters required to restore the dimension to the original dimension.

Alternatively, the first mapping layer, the second mapping layer and the third mapping layer may have different linear network structures.

In some embodiments, the first activation layer may be a SiLU activation layer or a HardSwish activation layer.

Particularly, the SiLU activation layer or the HardSwish activation layer performs an approximate suppression in a negative value region and nonlinear weighting in a positive small value region, which can preserve weak negative features for enabling finer feature filtering, and can avoid a loss of information in a saturation region.

Clearly, another activation layer may alternatively be adopted in the embodiment of the present disclosure to perform the feature filtering on the first sampled feature, for example, a traditional activation layer such as ReLU and Sigmoid, which is not limited in the present disclosure.

The second activation layer is configured to perform a normalization calculation according to the finally outputted output feature, and finally output the similarity score between the query term and the corresponding text. In some embodiments, the second activation layer may be a sigmoid layer.

In some embodiments, the similarity calculation sub-model further includes a fourth mapping layer. Here, the calculating based on the down-sampled feature using the second activation layer and outputting the correlation score between the query term sample and the candidate text sample includes: performing dimension mapping on the down-sampled feature using the fourth mapping layer to obtain the output feature of the output dimension; and inputting the output feature of the output dimension into the second activation layer for calculation, and outputting the correlation score between the query term sample and the candidate text sample.

Here, the configuration of the fourth mapping layer is similar to that of the first mapping layer, the second mapping layer and/or the third mapping layer, and a suitable linear mapping layer may be selected or parameters of the linear mapping layer may be set based on a change of the dimension, and thus, the details will not be repeatedly described here.

In some embodiments, the similarity calculation sub-model further includes a random deactivation layer and a normalization layer. Here, performing the down-sampling mapping on the enhanced feature using the fourth mapping layer to obtain the down-sampled feature of the output dimension includes: inputting the down-sampled feature into the random deactivation layer for over-fitting processing to output a processed feature; inputting the processed feature into the normalization layer for normalization processing to output a normalized feature; and inputting the normalized feature into the fourth mapping layer for the dimension mapping to obtain the output feature of the output dimension.

In other words, in the embodiment of the present disclosure, the random deactivation layer (dropout) and the normalization layer are added to the similarity calculation sub-model, so as to improve the stability of the training process and the robustness of the text retrieval model.

For step 202 in FIG. 2, the feature extraction sub-model is configured to extract the hidden-layer feature according to the character string sample. A detailed implementation is given below.

In some embodiments, the feature extraction sub-model is a large language model.

Particularly, in the large language model (LLM), a token is a basic unit of text processing, which is similar to a “word” or “sub-word” in the language. When processing the inputted character string sample, the LLM can compress the information in the character string sample into one token (i.e., the aggregate token described above), which servers as the last token of the character string sample. Inside the LLM, the model calculates a high-dimensional vector representation for each token in an input sequence at each layer, and this high-dimensional vector contains the rich semantic and syntax information of the token learned by the LLM according to the context, thus obtaining the hidden-layer features respectively corresponding to the respectively split tokens. The last token refers to the last basic unit (a word, a sub-word, or a character) obtained after the model performs word segmentation processing on the input sequence (the character string sample in the present disclosure).

Here, the hidden-layer feature corresponding to the last token aggregates the information of the entire character string. A plurality of hidden-layer features obtained by splitting the split character string correspond to the hidden-layer features of the respective tokens. By providing the hidden-layer feature of the last token and the hidden-layer feature of each token with corresponding weights, the global hidden-layer feature is calculated and obtained based on the weights, and the global hidden-layer feature is used as the input to the similarity calculation sub-model, thereby improving the training efficiency of model training.

For step 205 in FIG. 2, the text retrieval model is trained by means of the contrastive learning. A detailed implementation is given below.

In some embodiments, candidate text samples are divided into positive text samples and negative text samples, and correspondingly, the correlation scores includes a positive correlation score between the query term sample and the positive text sample and a negative correlation score between the query term sample and the negative text sample. Here, the training, based on the correlation score, the text retrieval model by means of contrastive learning includes: inputting the positive correlation score and the negative correlation score into a preset loss function to calculate and obtain a loss value; and training the text retrieval model based on the loss value.

Particularly, candidate samples in the contrastive learning are divided into positive text samples and negative text samples. Here, a positive text sample refers to a sample correlated to the query term sample, and a negative text sample refers to a sample uncorrelated to the query term sample.

For example, the query term is “How to treat insomnia?” A corresponding positive text sample may be: “Five recommended methods by doctors to improve sleep quality” (a document title or fragment). A negative text sample may be: “Latest mattress promotion advertisement in 2023” (uncorrelated to insomnia treatment).

The purpose of training the text retrieval model by means of the contrastive learning is to make the positive correlation score corresponding to the positive text sample as high as possible, and the negative correlation score corresponding to the negative text sample as low as possible. The positive correlation score and the negative correlation score are inputted into the preset loss function to calculate the corresponding loss value, and the feature extraction sub-model and the correlation score sub-model in the text retrieval model are optimized according to the loss value until the calculated loss value meets a preset condition, thus completing the training for the text retrieval model.

According to the embodiment of the present disclosure, the model is trained by means of the contrastive learning, that is, the structure of the feature space is learned by pulling the correlated sample closer and pushing the uncorrelated sample further away.

In some embodiments, the preset loss function is an information noise contrastive loss.

The information noise contrastive loss (Information Noise Contrastive Estimation Loss, InfoNCE Loss) trains the model by maximizing the similarity between the query term and the positive sample and minimizing the similarity between the query term and the negative sample.

For a deeper understanding, an embodiment of the present disclosure further provides a detailed implementation in combination with a detailed application scenario.

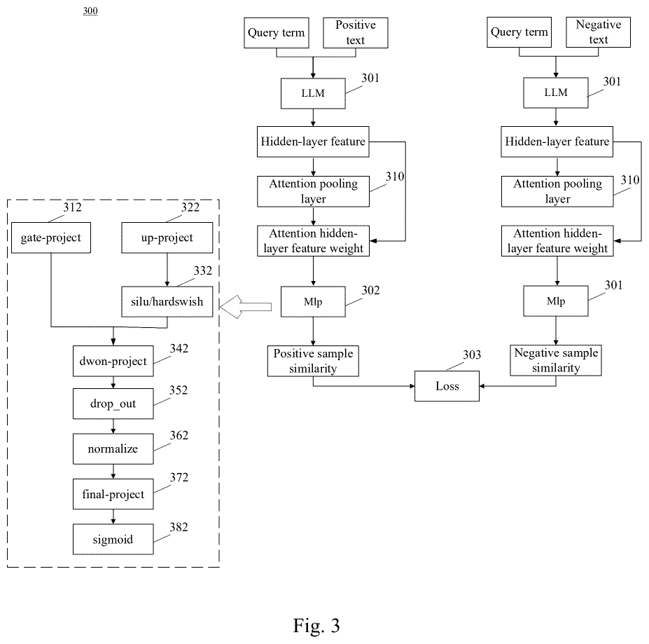

Referring to FIG. 3, FIG. 3 is a flowchart of a method for training a text retrieval model in combination with an application scenario provided by an embodiment of the present disclosure. As shown in FIG. 3, the method particularly includes the following steps.

Step 301, inputting a query term and a positive text, and the query term and a negative text, into the LLM.

Particularly, each pair of the query term and the positive text is compressed into one positive character string, and each pair of the query term and the negative text is compressed into one negative character string. Then, the positive character string and the negative character string are used as inputs to the LLM, and are inputted into the LLM. The LLM processes the inputted positive character string and negative character string, to respectively obtain the hidden-layer feature of the last token corresponding to the positive character string and the hidden-layer feature of the last token corresponding to the negative character string.

Step 310, inputting the hidden-layer features into an attention pooling layer to obtain attention hidden-layer feature weights.

Particularly, the hidden-layer feature weights of different tokens are extracted by the attention pooling layer based on the hidden-layer feature. Here, for the details of the extraction of the attention pooling layer for the hidden-layer feature weight, reference may be made to the above related embodiment, and thus, the details will not be repeatedly described here.

Step 302, inputting respectively the obtained attention hidden-layer feature weights and the hidden-layer features into an MLP for processing.

Particularly, a global hidden-layer feature is obtained by performing a multiplication on the attention hidden-layer feature weight and the original hidden-layer feature and summing the multiplication results, and finally the global hidden-layer feature is converted into the correlation score between the query term and a candidate text through the MLP, and accordingly, candidate texts of a positive sample and a negative sample each obtains a score. The process that the MLP obtains the positive correlation score corresponding to the positive candidate text sample is the same as the process that the MLP obtains the negative correlation score corresponding to the negative candidate text sample. The process that the MLP obtains the positive correlation score corresponding to the positive candidate text sample is taken as an example for illustration, and this process particularly includes the following steps.

Step 312, inputting a global hidden-layer feature corresponding to a positive character string into gate-project (a gate projection layer) for first up-sampling mapping to output a first up-sampled feature.

Step 322, inputting a hidden-layer feature, corresponding to a positive character string and corresponding to an obtained positive correlation score corresponding to positive candidate text sample, into up-project (an up-projection layer) for second up-sampling mapping, to output a second up-sampled feature.

Step 332, inputting the second up-sampled feature into silu/hardswish to perform feature filtering on the second up-sampled feature to generate a filtered feature.

Here, step 312 may be performed in parallel with steps 322 and 332 to speed up model training. The structures of the projection layers corresponding to step 312 and step 322 are the same, and the corresponding parameters may be different or the same.

Step 342, performing down-sampling process using down-project (a down-projection layer) according to the first sampled feature and the filtered feature, to generate a down-sampled feature.

Particularly, first, a self-attention multiplication is performed on the first sampled feature and the filtered feature for self-attention enhancement on the hidden-layer feature, to generate an enhanced feature; then, the enhanced feature is inputted into the down-project, and the down-project projects the enhanced feature back to the original dimension to obtain the down-sampled feature.

Step 352, inputting the down-sampled feature into drop_out for processing to obtain a processed feature.

Particularly, the down-sampled feature is processed by the drop_out, to prevent a text retrieval model from being over-fitted during training.

Step 362, inputting the processed feature into normalize for normalization processing, and outputting a normalized feature.

Step 372, inputting the normalized feature into final-project to obtain an output feature. That is, mapping the normalized feature to an output dimension.

Step 382, inputting the output feature into sigmoid to obtain a positive sample similarity (which may be a positive correlation score) between a query term sample and a positive text sample. That is, the sigmoid normalizes the output feature to a score.

The global hidden-layer feature corresponding to the negative character string is processed using the steps same as the above steps 312-382, to obtain a corresponding negative sample similarity degree (which may be a negative correlation score) between the query term sample and a negative text sample. Here, the process that the MLP processes the global hidden-layer feature corresponding to the positive character string may be performed in parallel with the process that the MLP processes the global hidden-layer feature corresponding to the negative character string, thereby improving the training efficiency of the model.

Step 303, inputting the positive sample similarity and a negative sample similarity into loss (a loss model) to calculate corresponding loss values, and performing model training on the LLM and the MLP based on the loss values.

According to the method for training the text retrieval model provided in embodiments of the present disclosure, the query term and the corresponding candidate text are compressed into one character string, and the character string is used as the input to the feature extraction sub-model, such that the feature extraction sub-model can directly learn the context dependency relationship between the query term and the text, thereby improving the precision of the obtained hidden-layer feature. Further, the hidden-layer feature weight corresponding to each token is calculated, and the global hidden-layer feature is calculated by weighting the hidden-layer feature corresponding to each token based on the hidden-layer feature weight corresponding to each token and the original hidden-layer feature. The resolution of the global hidden-layer feature can be improved by performing the up-sampling on the global hidden-layer feature, thus obtaining the spatial details in the global hidden-layer feature, and the feature filtering is performed on the unimportant features based on the spatial details in the global hidden-layer feature. Then, the feature is compressed to an original dimension by performing the down-sampling according to the up-sampled feature and the filtered feature, such that the down-sampled feature can better express the feature in the character string sample, and thus, the correlation score between the query term sample and the candidate sample that is calculated according to the down-sampled feature will become more accurate, thereby improving the feature extraction effect of the similarity calculation sub-model. Moreover, the text retrieval model is trained by means of the contrastive learning, thereby improving the efficiency and accuracy of model training.

The above embodiments illustrate how to train the text retrieval model from various aspects. In order to highlight the effect of the trained text retrieval model as much as possible in an actual use scenario, an embodiment of the present disclosure further provides a scheme of solving an actual problem using the trained text retrieval model.

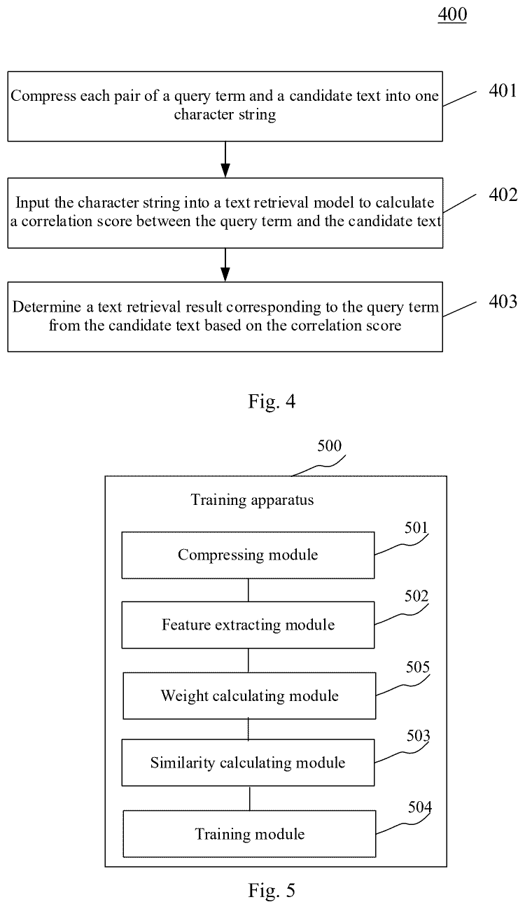

FIG. 4 is a flowchart 400 of a method for retrieving a text provided by an embodiment of the present disclosure. Referring to FIG. 4, this method particularly includes the following steps.

Step 401, compressing a query term and a candidate text into one character string.

Step 402, inputting the character string into the text retrieval model to calculate a correlation score between the query term and the candidate text.

Step 403, determining a text retrieval result corresponding to the query term from the candidate text based on the correlation score.

Here, the text retrieval model is obtained according to any one of the above embodiments of the method for training the text retrieval model.

This embodiment exists as a model inference embodiment corresponding to the above embodiment of the model training method. According to the method for retrieving a text provided in this embodiment, the correlation score between the query term and the candidate text is calculated using the text retrieval model obtained through the method for training a text retrieval model provided in the above embodiment, which makes the calculated correlation score more accurate, and accordingly, the accuracy and efficiency of the retrieval result obtained through the retrieval performed on the candidate text based on the correlation score becomes higher.

In some embodiments, the inputting the character string into a text retrieval model to calculate a correlation score between the query term and the candidate text in step 402 particularly includes: processing the character string using a feature extraction sub-model in the text retrieval model to obtain hidden-layer features of tokens in the character string; calculating feature weights of the hidden-layer features of the tokens using a weight determination sub-model in the text retrieval model; and calculating, based on feature weights and hidden-layer features of corresponding tokens, to obtain the correlation score between the query term and the candidate text using a similarity calculation sub-model in the text retrieval model.

In some embodiments, the processing the character string using a feature extraction sub-model in the text retrieval model to obtain hidden-layer features of tokens in the character string includes: processing the character string using the feature extraction sub-model in the text retrieval model to generate an aggregate token; splitting the character string into a plurality of split tokens using the feature extraction sub-model; and performing a feature extraction on a plurality of tokens containing the aggregate token and the plurality of split tokens using the feature extraction sub-module, and outputting the hidden-layer features of the tokens.

In some embodiments, the calculating feature weights of the hidden-layer features of the tokens using a weight determination sub-model in the text retrieval model includes: determining a linguistic feature of a token using the weight determination sub-model in the text retrieval model; and calculating the feature weight of the hidden-layer feature of the token based on the linguistic feature of the token.

In some embodiments, the processing the character string using a feature extraction sub-model in the text retrieval model to obtain hidden-layer features of tokens in the character string includes: outputting hidden-layer sub-features corresponding to the tokens using network layers in the feature extraction sub-model; determining network weights of the hidden-layer sub-features outputted from the network layers in the feature extraction sub-model; and determining the hidden-layer features corresponding to the tokens based on the network weights and the corresponding hidden-layer sub-features.

In some embodiments, the weight determination sub-model is an attention pooling layer.

In some embodiments, the calculating, based on the feature weights and the hidden-layer features of corresponding tokens and using a similarity calculation sub-model in the text retrieval model, to obtain a correlation score between the query term and the candidate text using a similarity calculation sub-model in the text retrieval model includes: multiplying the feature weights by the hidden-layer features of the corresponding tokens to obtain a plurality of multiplication results; summing the plurality of multiplication results to obtain a global hidden-layer feature; and inputting the global hidden-layer feature into the similarity calculation sub-model for calculation, and outputting the correlation score between the query term and the candidate text.

In some embodiments, the inputting the global hidden-layer feature into the similarity calculation sub-model for calculation, and outputting the correlation score between the query term and the candidate text includes: performing a correlation score calculation operation on the global hidden-layer feature using the similarity calculation sub-model in the text retrieval model: performing up-sampling mapping on the global hidden-layer feature to obtain an up-sampled feature and performing feature filtering on the up-sampled feature to obtain a filtered feature; performing down-sampling mapping on the filtered feature and the up-sampled feature to obtain a down-sampled feature; and calculating, based on the down-sampled feature, the correlation score between the query term and the candidate text.

In some embodiments, performing up-sampling mapping on the global hidden-layer feature using a similarity calculation sub-model in the text retrieval model to obtain the up-sampled feature, and performing feature filtering on the up-sampled feature to obtain the filtered feature, and performing down-sampling mapping on the filtered feature and the up-sampled feature to obtain a down-sampled feature particularly include: performing first up-sampling mapping on the global hidden-layer feature using the similarity calculation sub-model in the text retrieval model to obtain a first up-sampled feature, and performing the feature filtering on the first up-sampled feature to obtain a filtered feature; performing second up-sampling mapping on the global hidden-layer feature to obtain a second up-sampled feature; and performing down-sampling mapping on the hidden-layer feature according to the filtered feature and the second up-sampled feature to obtain the down-sampled feature.

In some embodiments, performing the down-sampling mapping on the filtered feature and the second up-sampled feature to obtain the down-sampled feature includes: performing a self-attention multiplication on the filtered feature and the second up-sampled feature to obtain an enhanced feature; and performing the down-sampling mapping on the enhanced feature to obtain the down-sampled feature.

In some embodiments, the calculating the correlation score between the query term and the candidate text based on the down-sampled feature includes: performing dimension mapping on the down-sampled feature to obtain an output feature of an output dimension; and calculating the correlation score between the query term and the candidate text based on the output feature of the output dimension.

In some embodiments, the similarity calculation sub-model includes a first mapping layer, a second mapping layer, a first activation layer, a third mapping layer, and a second activation layer. The performing a correlation score calculation operation on the global hidden-layer feature using the similarity calculation sub-model in the text retrieval model includes: inputting the global hidden-layer feature into the first mapping layer for the first up-sampling mapping to output the first up-sampled feature, and performing the feature filtering on the first up-sampled feature using the first activation layer to output the filtered feature; inputting the global hidden-layer feature into the second mapping layer for the second up-sampling mapping to output the second up-sampled feature; inputting the filtered feature and the second up-sampled feature into the third mapping layer for the down-sampling mapping to output the down-sampled feature; and performing calculation on the down-sampled feature using the second activation layer and outputting the correlation score between the query term and the candidate text.

In some embodiments, the similarity calculation sub-model further includes a fourth mapping layer. Here, the calculating the down-sampled feature using the second activation layer and outputting the correlation score between the query term and the candidate text includes: performing the dimension mapping on the down-sampled feature using the fourth mapping layer to obtain the output feature of the output dimension; and inputting the output feature of the output dimension into the second activation layer for calculation, and outputting the correlation score between the query term and the candidate text.

In some embodiments, the feature extraction sub-model is a large language model.

According to the embodiment of the present disclosure, the query term and the corresponding candidate text are compressed into one character string, and the character string is used as the input to the feature extraction sub-model, such that the feature extraction sub-model can directly learn the context dependency relationship between the query term and the text, thereby improving the precision of the obtained hidden-layer feature. Further, the global feature of the character string is determined by determining the weights of the hidden-layer features corresponding to tokens in the character string, and the correlation score between the query term and the candidate text is calculated based on the global feature of the character string, which makes the calculated correlation score more accurate. Accordingly, by performing a text retrieval based on this correlation score, the precision and accuracy of the text retrieval can be improved.

Further, the resolution of the global hidden-layer feature can be improved by performing the up-sampling on the global hidden-layer feature, thereby obtaining the spatial details in the global hidden-layer feature. Moreover, the feature filtering is performed on unimportant features based on the spatial details in the global hidden-layer feature. Then, the feature is compressed to an original dimension by performing the down-sampling according to the up-sampled feature and the filtered feature, such that the down-sampled feature can better express the feature in the character string, and thus, the correlation score between the query term and the candidate text that is calculated according to the down-sampled feature will become more accurate. Further, the text retrieval result determined based on the correlation score between the query term and the candidate text becomes more accurate, and the retrieval efficiency becomes higher.

Further referring to FIG. 5 and FIG. 6, as implementations of the methods shown in the above drawings, an embodiment of the present disclosure respectively provides an apparatus for training a text retrieval model and an embodiment of an apparatus for retrieving a text. The embodiment of the apparatus for training a text retrieval model corresponds to the embodiment of the method for training a text retrieval model shown in FIG. 2, and the embodiment of the apparatus for retrieving a text corresponds to the embodiment of the method for retrieving a text. The above apparatuses may be applied in various electronic devices.

As shown in FIG. 5, an apparatus 500 for training a text retrieval model in this embodiment may include: a compressing module 501, a feature extracting module 502, a weight calculating module 505, a similarity calculating module 503 and a training module 504. Here, the compressing module 501 is configured to compress each pair of a query term sample and a candidate text sample into one character string sample. The feature extracting module 502 is configured to process the character string sample using a feature extraction sub-model in a text retrieval model to obtain hidden-layer features of tokens in the character string sample. The weight calculating module 505 is configured to calculate feature weights of the hidden-layer features of the tokens using a weight determination sub-model in the text retrieval model. The similarity calculating module 503 is configured to calculate, based on the feature weights and the hidden-layer features of the corresponding tokens and using a similarity calculation sub-model in the text retrieval model, to obtain a correlation score between the query term sample and the candidate text sample. The training module 504 is configured to train, based on the correlation score, the text retrieval model by means of contrastive learning.

In this embodiment, for detailed processes of the compressing module 501, the feature extracting module 502, the weight calculating module 505, the similarity calculating module 503 and the training module 504 in the apparatus 500 for training a text retrieval model, and their technical effects, reference may be respectively made to the related descriptions of steps 201-204 in the corresponding embodiment of FIG. 2, and thus the detailed processes and the technical effects will not be repeatedly described here.

In some embodiments, the feature extracting module 502 is particularly configured to: process the character string sample using the feature extraction sub-model in the text retrieval model to generate an aggregate token; split the character string sample into a plurality of split tokens using the feature extraction sub-model; and perform feature extraction on a plurality of tokens containing the aggregate token and the plurality of split tokens using the feature extraction sub-module, and outputting the hidden-layer features of the tokens.

In some embodiments, the weight calculating module 505 is particularly configured to: determine a linguistic feature of a token using the weight determination sub-model in the text retrieval model; and calculate the feature weight of the hidden-layer feature of the token based on the linguistic feature of the token.

In some embodiments, the weight calculating module 505 is particularly configured to: output hidden-layer sub-features corresponding to the tokens using network layers in the feature extraction sub-model; determine network weights of the hidden-layer sub-features outputted from the network layers in the feature extraction sub-model; and determine the hidden-layer features corresponding to the tokens based on the network weights and the corresponding hidden-layer sub-features.

In some embodiments, the weight determination sub-model is an attention pooling layer.

In some embodiments, the similarity calculating module 503 is particularly configured to: multiply the feature weights by the hidden-layer features of the corresponding tokens to obtain a plurality of multiplication results, and sum the plurality of multiplication results to obtain a global hidden-layer feature; and input the global hidden-layer feature into the similarity calculation sub-model for calculation, and output the correlation score between the query term sample and the candidate text sample.

In some embodiments, the similarity calculating module 503 is particularly configured to: perform correlation score calculation using the similarity calculation sub-model in the text retrieval model: perform up-sampling mapping on the global hidden-layer feature to obtain an up-sampled feature, and perform feature filtering on the up-sampled feature to obtain a filtered feature; perform down-sampling mapping on the filtered feature and the up-sampled feature to obtain a down-sampled feature; and calculate, based on the down-sampled feature, the correlation score between the query term sample and the candidate text sample.

In some embodiments, the similarity calculating module 503 is particularly configured to: perform first up-sampling mapping on the global hidden-layer feature to obtain a first up-sampled feature, and perform the feature filtering on the first up-sampled feature to obtain a filtered feature; perform second up-sampling mapping on the global hidden-layer feature to obtain a second up-sampled feature; and perform the down-sampling mapping on the filtered feature and the second up-sampled feature to obtain the down-sampled feature.

In some embodiments, the similarity calculating module 503 is particularly configured to: perform self-attention multiplication on the filtered feature and the second up-sampled feature to obtain an enhanced feature; and performing the down-sampling mapping on the enhanced feature to obtain the down-sampled feature.

In some embodiments, the similarity calculating module 503 is particularly configured to: perform dimension mapping on the down-sampled feature to obtain an output feature of an output dimension; and calculate the correlation score between the query term sample and the candidate text sample based on the output feature of the output dimension.

In some embodiments, the similarity calculating module 503 is particularly configured to: perform over-fitting processing on the down-sampled feature to obtain a processed feature; perform normalization processing on the processed feature to obtain a normalized feature; and perform the dimension mapping on the normalized feature to obtain the output feature of the output dimension.

In some embodiments, the similarity calculation sub-model includes a first mapping layer, a second mapping layer, a first activation layer, a third mapping layer, and a second activation layer. The similarity calculating module 503 is particularly configured to: input the global hidden-layer feature into the first mapping layer for the first up-sampling mapping to output the first up-sampled feature, and perform the feature filtering on the first up-sampled feature using the first activation layer to output the filtered feature; input the global hidden-layer feature into the second mapping layer for the second up-sampling mapping to output the second up-sampled feature; input the filtered feature and the second up-sampled feature into the third mapping layer for the down-sampling mapping to output the down-sampled feature; and perform calculation on the down-sampled feature using the second activation layer and output the correlation score between the query term sample and the candidate text sample.

In some embodiments, the similarity calculation sub-model further includes a fourth mapping layer. The similarity calculating module 503 is particularly configured to: perform the dimension mapping on the down-sampled feature using the fourth mapping layer to obtain the output feature of the output dimension; and input the output feature of the output dimension into the second activation layer for calculation, and output the correlation score between the query term sample and the candidate text sample.

In some embodiments, the similarity calculation sub-model further includes a random deactivation layer and a normalization layer. The similarity calculating module 503 is particularly configured to: input the down-sampled feature into the random deactivation layer for over-fitting processing to output a processed feature; input the processed feature into the normalization layer for normalization processing to output a normalized feature; and input the normalized feature into the fourth mapping layer for the dimension mapping to obtain the output feature of the output dimension.

In some embodiments, the feature extraction sub-model is a large language model.

In some embodiments, candidate text samples are divided into positive text samples and negative text samples, and correspondingly, correlation scores includes a positive correlation score between the query term sample and the positive text sample, and a negative correlation score between the query term sample and the negative text sample. The training module 504 is particularly configured to: input the positive correlation score and the negative correlation score into a preset loss function to calculate and obtain loss values; and train the text retrieval model based on the loss values.

In some embodiments, the preset loss function is an information noise contrastive loss.

As shown in FIG. 6, an apparatus 600 for retrieving a text in an embodiment may include: a compressing unit 601, a correlation score calculating unit 602 and a retrieving unit 603. Here, the compressing unit 601 is configured to compress a query term and a candidate text into a character string. The correlation score calculating unit 602 is configured to input the character string into a text retrieval model to calculate a correlation score between the query term and the candidate text. Here, the text retrieval model is obtained according to the apparatus in any of the above embodiments of the apparatus for training a text retrieval model. The retrieving unit 603 is configured to determine a text retrieval result corresponding to the query term from the candidate text based on the correlation score.

In this embodiment, for detailed processes of the compressing unit 601, the correlation score calculating unit 602 and the retrieving unit 603 in the apparatus 600 for retrieving a text, and their technical effects, reference may be respectively made to the related descriptions in the corresponding method embodiment, and thus the detailed processes and the technical effects will not be repeatedly described here.

The embodiments exist as apparatus embodiments corresponding to the above method embodiments. According to the apparatus for training a text retrieval model provided in the embodiment of the present disclosure and the apparatus for retrieving a text provided in the embodiment of the present disclosure, the query term and the corresponding candidate text are compressed into one character string, and the character string is used as the input to the feature extraction sub-model, such that the feature extraction sub-model can directly learn the context dependency relationship between the query term and the text, thereby improving the precision of the obtained hidden-layer feature. Further, the global feature of the character string sample is determined by determining the weights of the hidden-layer features corresponding to the respective tokens in the character string sample, and the correlation score between the query term sample and the candidate text sample is calculated based on the global feature of the character string sample, which makes the calculated correlation score more accurate. Accordingly, by training the text retrieval model based on this correlation score, the precision and accuracy of training the text retrieval model can be improved.

According to an embodiment of the present disclosure, an electronic device is provided. The electronic device comprises at least one processor, and a memory in communication with the at least one processor. Here, the memory stores instructions executable by the at least one processor, and the instructions are executed by the at least one processor, to enable the at least one processor to implement the method for training a text retrieval model and/or the method for retrieving a text described in any of the above embodiments.

According to an embodiment of the present disclosure, the present disclosure further provides a readable storage medium. The readable storage medium stores a computer instruction. The computer instruction is used to enable a computer to implement the method for training a text retrieval model and/or the method for retrieving a text described in any of the above embodiments.

An embodiment of the present disclosure provides a computer program product. The computer program, when executed by a processor, can implement the method for training a text retrieval model and/or the method for retrieving a text described in any of the above embodiments.

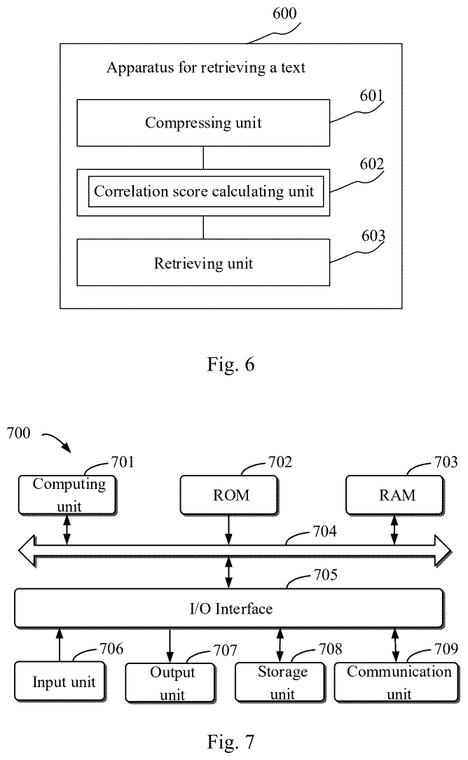

FIG. 7 is a schematic block diagram of an example electronic device 700 that may be used to implement embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may alternatively represent various forms of mobile apparatuses such as personal digital processing, a cellular telephone, a smart phone, a wearable device and other similar computing apparatuses. The parts shown herein, their connections and relationships, and their functions are only as examples, and not intended to limit the implementations of the present disclosure described and/or claimed herein.

As shown in FIG. 7, the electronic device 700 includes a computing unit 701, which may execute various appropriate actions and processes in accordance with a program stored in a read-only memory (ROM) 702 or a program loaded into a random access memory (RAM) 703 from a storage portion 707. The RAM 703 also stores various programs and data required by operations of the device 700. The computing unit 701, the ROM 702 and the RAM 703 are connected to each other through a bus 704. An input/output (I/O) interface 705 is also connected to the bus 704.

A plurality of components in device 700 are connected to I/O interface 705, including an input unit 706, such as a keyboard, mouse, etc. ; an output unit 707, such as various types of displays, speakers, etc. ; a storage unit 708, such as magnetic disks, optical disks, etc. ; and communication units 709, such as network cards, modems, wireless communication transceivers, etc. The communication unit 709 allows device 700 to exchange information/data with other devices through computer networks such as the Internet and/or various telecommunications networks.

The computing unit 701 may be various general-purpose and/or special-purpose processing assemblies having processing and computing capabilities. Some examples of the computing unit 701 include, but not limited to, a central processing unit (CPU), a graphics processing unit (GPU), various dedicated artificial intelligence (AI) computing chips, various processors that run a machine learning model algorithm, a digital signal processor (DSP), any appropriate processor, controller and microcontroller, etc. The computing unit 701 performs the various methods and processes described above, for example, the method for training a text retrieval model and/or the method for retrieving a text. For example, in some embodiments, the method for training a text retrieval model and/or the method for retrieving a text may be implemented as a computer software program, which is tangibly included in a machine readable medium, for example, the storage unit 708. In some embodiments, part or all of the computer program may be loaded into and/or installed on the device 700 via the ROM 702 and/or the communication unit 709. When the computer program is loaded into the RAM 703 and executed by the computing unit 701, one or more operations of the above method for training a text retrieval model and/or the method for retrieving a text may be performed. Alternatively, in other embodiments, the computing unit 701 may be configured to perform the method for training a text retrieval model and/or the method for retrieving a text through any other appropriate approach (e.g., by means of firmware).

The various implementations of the systems and technologies described herein may be implemented in a digital electronic circuit system, an integrated circuit system, a field programmable gate array (FPGA), an application specific integrated circuit (ASIC), an application specific standard product (ASSP), a system-on-chip (SOC), a complex programmable logic device (CPLD), computer hardware, firmware, software and/or combinations thereof. The various implementations may include: being implemented in one or more computer programs, where the one or more computer programs may be executed and/or interpreted on a programmable system including at least one programmable processor, and the programmable processor may be a specific-purpose or general-purpose programmable processor, which may receive data and instructions from a storage system, at least one input device and at least one output device, and send the data and instructions to the storage system, the at least one input device and the at least one output device.

Program codes used to implement the method of embodiments of the present disclosure may be written in any combination of one or more programming languages. These program codes may be provided to a processor or controller of a general-purpose computer, specific-purpose computer or other programmable data processing apparatus, so that the program codes, when executed by the processor or controller, cause the functions or operations specified in the flowcharts and/or block diagrams to be implemented. These program codes may be executed entirely on a machine, partly on the machine, partly on the machine as a stand-alone software package and partly on a remote machine, or entirely on the remote machine or a server.

In the context of the present disclosure, the machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any appropriate combination thereof. A more specific example of the machine-readable storage medium may include an electronic connection based on one or more lines, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof.

To provide interaction with a user, the systems and technologies described herein may be implemented on a computer having: a display device (such as a CRT (cathode ray tube) or LCD (liquid crystal display) monitor) for displaying information to the user; and a keyboard and a pointing device (such as a mouse or a trackball) through which the user may provide input to the computer. Other types of devices may also be used to provide interaction with the user. For example, the feedback provided to the user may be any form of sensory feedback (such as visual feedback, auditory feedback or tactile feedback); and input from the user may be received in any form, including acoustic input, speech input or tactile input.

The systems and technologies described herein may be implemented in: a computing system including a background component (such as a data server), or a computing system including a middleware component (such as an application server), or a computing system including a front-end component (such as a user computer having a graphical user interface or a web browser through which the user may interact with the implementations of the systems and technologies described herein), or a computing system including any combination of such background component, middleware component or front-end component. The components of the systems may be interconnected by any form or medium of digital data communication (such as a communication network). Examples of the communication network include a local area network (LAN), a wide area network (WAN), and the Internet.

A computer system may include a client and a server. The client and the server are generally remote from each other, and generally interact with each other through the communication network. A relationship between the client and the server is generated by computer programs running on a corresponding computer and having a client-server relationship with each other. The Server could be a cloud server, also known as cloud computing server or cloud host, which is a host product in the cloud computing service system to solve the defects of difficult management and weak business scalability in the traditional physical host and Virtual Private server (VPS, Virtual Private Server) service. The server may also be classified as distributed system servers, or a server that combines a blockchain.

According to the technical solution of the embodiments of the present disclosure, a query term and a corresponding candidate text are compressed into one character string, and the character string is used as an input to a feature extraction sub-model, such that the feature extraction sub-model can directly learn the context dependency relationship between the query term and the text, thereby improving the precision of an obtained hidden-layer feature. Further, a global feature of a character string sample is determined by determining the weights of the hidden-layer features corresponding to the respective tokens in the character string sample, and the correlation score between the query term sample and the candidate text sample is calculated based on the global feature of the character string sample, which makes the calculated correlation score more accurate. Accordingly, by training a text retrieval model based on this correlation score, the precision and accuracy of training the text retrieval model can be improved.

It should be appreciated that the steps of reordering, adding or deleting may be executed using the various forms shown above. For example, the steps described in embodiments of the present disclosure may be executed in parallel or sequentially or in a different order, so long as the expected results of the technical schemas provided in embodiments of the present disclosure may be realized, and no limitation is imposed herein.

The above specific implementations are not intended to limit the scope of the present disclosure. It should be appreciated by those skilled in the art that various modifications, combinations, sub-combinations, and substitutions may be made depending on design requirements and other factors. Any modification, equivalent and modification that fall within the spirit and principles of the present disclosure are intended to be included within the scope of the present disclosure.

What is claimed is:

1. A method for training a text retrieval model, the method comprising:
compressing each pair of a query term sample and a candidate text sample into one character string sample;
processing the character string sample using a feature extraction sub-model in a text retrieval model to obtain hidden-layer features of tokens in the character string sample;
calculating feature weights of the hidden-layer features of the tokens using a weight determination sub-model in the text retrieval model;
calculating, based on the feature weights and the hidden-layer features of the corresponding tokens and using a similarity calculation sub-model in the text retrieval model, to obtain a correlation score between the query term sample and the candidate text sample; and
training, based on the correlation score, the text retrieval model by means of contrastive learning.

2. The method according to claim 1, wherein the processing the character string sample using a feature extraction sub-model in a text retrieval model to obtain hidden-layer features of tokens in the character string sample comprises:
processing the character string sample using the feature extraction sub-model in the text retrieval model to generate an aggregate token;
splitting the character string sample into a plurality of split tokens using the feature extraction sub-model; and
performing feature extraction on a plurality of tokens containing the aggregate token and the plurality of split tokens using the feature extraction sub-module, and outputting the hidden-layer features of the tokens.

3. The method according to claim 1, wherein the processing the character string sample using a feature extraction sub-model in a text retrieval model to obtain hidden-layer features of tokens in the character string sample comprises:
outputting hidden-layer sub-features corresponding to the tokens using network layers in the feature extraction sub-model;
determining network weights of the hidden-layer sub-features outputted from the network layers in the feature extraction sub-model; and
determining the hidden-layer features corresponding to the tokens based on the network weights and the corresponding hidden-layer sub-features.

4. The method according to claim 1, wherein the calculating feature weights of the hidden-layer features of the tokens using a weight determination sub-model in the text retrieval model comprises:
determining a linguistic feature of a token using the weight determination sub-model in the text retrieval model; and
calculating the feature weight of the hidden-layer feature of the token based on the linguistic feature of the token.

5. The method according to claim 1, wherein the weight determination sub-model is an attention pooling layer.

6. The method according to claim 1, wherein the calculating, based on the feature weights and the hidden-layer features of the corresponding tokens and using a similarity calculation sub-model in the text retrieval model, to obtain a correlation score between the query term sample and the candidate text sample comprises:
multiplying the feature weights by the hidden-layer features of the corresponding tokens to obtain a plurality of multiplication results; and summing the plurality of multiplication results to obtain a global hidden-layer feature; and
inputting the global hidden-layer feature into the similarity calculation sub-model for calculation, and outputting the correlation score between the query term sample and the candidate text sample.

7. The method according to claim 6, wherein the inputting the global hidden-layer feature into the similarity calculation sub-model for calculation, and outputting the correlation score between the query term sample and the candidate text sample comprises:
performing correlation score calculation using the similarity calculation sub-model in the text retrieval model, comprising:
performing up-sampling mapping on the global hidden-layer feature to obtain an up-sampled feature, and performing feature filtering on the up-sampled feature to obtain a filtered feature;
performing down-sampling mapping on the filtered feature and the up-sampled feature to obtain a down-sampled feature; and
calculating, based on the down-sampled feature, the correlation score between the query term sample and the candidate text sample.

8. The method according to claim 7, wherein the similarity calculation sub-model comprises a first mapping layer, a second mapping layer, a first activation layer, a third mapping layer and a second activation layer, and
the inputting the global hidden-layer feature into the similarity calculation sub-model for calculation, and outputting the correlation score between the query term sample and the candidate text sample comprises:
inputting the global hidden-layer feature into the first mapping layer for first up-sampling mapping to output a first up-sampled feature, and performing the feature filtering on the first up-sampled feature using the first activation layer to output a filtered feature;
inputting the global hidden-layer feature into the second mapping layer for second up-sampling mapping to output a second up-sampled feature;
inputting the filtered feature and the second up-sampled feature into the third mapping layer for down-sampling mapping to output the down-sampled feature; and
performing calculation on the down-sampled feature using the second activation layer, and outputting the correlation score between the query term sample and the candidate text sample.

9. The method according to claim 8, wherein the similarity calculation sub-model comprises a fourth mapping layer, and
the calculating, based on the down-sampled feature, the correlation score between the query term sample and the candidate text sample comprises:
performing dimension mapping on the down-sampled feature using the fourth mapping layer to obtain an output feature of an output dimension; and
inputting the output feature of the output dimension into the second activation layer for calculation, and outputting the correlation score between the query term sample and the candidate text sample.

10. The method according to claim 9, wherein the similarity calculation sub-model further comprises a random deactivation layer and a normalization layer, and
the performing dimension mapping on the down-sampled feature using the fourth mapping layer to obtain an output feature of an output dimension comprises:
inputting the down-sampled feature into the random deactivation layer for over-fitting processing to output a processed feature;
inputting the processed feature into the normalization layer for normalization processing to output a normalized feature; and
inputting the normalized feature into the fourth mapping layer for the dimension mapping to obtain the output feature of the output dimension.

11. The method according to claim 1, wherein the feature extraction sub-model is a large language model.

12. The method according to claim 1, wherein candidate text samples are divided into positive text samples and negative text samples, and correspondingly, correlation scores comprises a positive correlation score between the query term sample and the positive text sample and a negative correlation score between the query term sample and the negative text sample, and
the training, based on the correlation score, the text retrieval model by means of contrastive learning comprises:
inputting the positive correlation score and the negative correlation score into a preset loss function to calculate and obtain a loss value; and
training the text retrieval model based on the loss value.

13. A method for retrieving a text, by using the text retrieval model obtained according to claim 1, the method comprising:
compressing a query term and a candidate text into one character string;
inputting the character string into the text retrieval model to calculate a correlation score between the query term and the candidate text; and
determining a text retrieval result corresponding to the query term from the candidate text based on the correlation score.

14. An apparatus for training a text retrieval model, the apparatus comprising:
at least one processor; and
a memory, in communication with the at least one processor,
wherein the memory stores instructions executable by the at least one processor, and the instructions are executed by the at least one processor, to enable the at least one processor to perform operations comprising:
compressing each pair of a query term sample and a candidate text sample into one character string sample;
processing the character string sample using a feature extraction sub-model in a text retrieval model to obtain hidden-layer features of tokens in the character string sample;
calculating feature weights of the hidden-layer features of the tokens using a weight determination sub-model in the text retrieval model;
calculating, based on the feature weights and the hidden-layer features of the corresponding tokens and using a similarity calculation sub-model in the text retrieval model, to obtain a correlation score between the query term sample and the candidate text sample; and
training, based on the correlation score, the text retrieval model by means of contrastive learning.

15. The apparatus according to claim 14, wherein the similarity calculation sub-model comprises a first mapping layer, a second mapping layer, a first activation layer, a third mapping layer and a second activation layer, and
the calculating, based on the feature weights and the hidden-layer features of the corresponding tokens and using a similarity calculation sub-model in the text retrieval model, to obtain a correlation score between the query term sample and the candidate text sample, comprises: performing, based on the feature weights and the corresponding hidden-layer features, first up-sampling mapping using the first mapping layer to output a first up-sampled feature, and performing feature filtering on the first up-sampled feature using the first activation layer to output a filtered feature;
performing, based on the feature weights and the corresponding hidden-layer features, second up-sampling mapping using the second mapping layer to output a second up-sampled feature;
inputting the filtered feature and the second up-sampled feature into the third mapping layer for down-sampling mapping, to output a down-sampled feature; and
performing calculation on the down-sampled feature using the second activation layer and output the correlation score between the query term sample and the candidate text sample.

16. An apparatus for retrieving a text, by using the text retrieval model obtained according to claim 1, the apparatus comprising:
a compressing unit, configured to compress a query term and a candidate text into one character string;
a correlation score calculating unit, configured to input the character string into the text retrieval model to calculate a correlation score between the query term and the candidate text; and
a retrieving unit, configured to determine a text retrieval result corresponding to the query term from the candidate text based on the correlation score.

17. A non-transitory computer readable storage medium, storing a computer instruction, wherein the computer instruction is used to cause a computer to perform operations comprising:
compressing each pair of a query term sample and a candidate text sample into one character string sample;
processing the character string sample using a feature extraction sub-model in a text retrieval model to obtain hidden-layer features of tokens in the character string sample;
calculating feature weights of the hidden-layer features of the tokens using a weight determination sub-model in the text retrieval model;
calculating, based on the feature weights and the hidden-layer features of the corresponding tokens and using a similarity calculation sub-model in the text retrieval model, to obtain a correlation score between the query term sample and the candidate text sample; and
training, based on the correlation score, the text retrieval model by means of contrastive learning.
